(19) United States
(12) Patent Application Publication
(10) Pub. No.: US 2015/0159791 A1
(43) Pub. Date: Jun. 11, 2015

(54) RADIALLY COMPRESSED STRAIGHT TUBE SEAL ASSEMBLY

(71) Applicant: DELPHI TECHNOLOGIES, INC., TROY, MI (US)

(72) Inventor: KARL J. HALTINER, JR., FAIRPORT, NY (US)

(21) Appl. No.: 14/098,612

(22) Filed: Dec. 6, 2013

(51) Int. Cl. F16L 23/16

(52) U.S. Cl. CPC F16L 23/16

(57) ABSTRACT

A seal assembly configured to provide a fluidic seal between openings into objects. A first object is configured to define a first opening that includes a first tapered section tapered from a first start diameter to a first finish diameter. A second object is configured to define a second opening that includes a second tapered section tapered from a second start diameter to a second finish diameter. The assembly includes a straight tube characterized by an outer diameter less than the first start diameter and the second start diameter, and greater than the first finish diameter and the second finish diameter. A fluidic seal is formed when the first object and the second object are forced together with the straight tube therebetween such that the first tapered section and the second tapered section deform the straight tube to form a seal therebetween by radial compression of the straight tube.

### GOVERNMENT LICENSE RIGHTS STATEMENT

This invention was made with the United States Government support under Contract DE-NT003894 or DE-FC26-08NT0003894 awarded by the U.S. Department of Energy. The Government has certain rights in this invention.

### TECHNICAL FIELD OF INVENTION

This disclosure generally relates to a seal assembly configured to provide a fluidic seal between openings into objects, and more particularly relates to providing tapered sections to deform a straight tube by radial compression to form a fluidic seal.

### BACKGROUND OF INVENTION

It is desirable to provide a low cost and reliable low leak seal joint between objects in high temperature applications such as a solid oxide fuel cell (SOFC). Different types of commercially available seal technologies have been tested with unsatisfactory results. The technologies tested include metal C-rings that are an O-ring type seal fabricated from a high temperature alloy having a ‘C’ shaped cross-section. Metal C-rings rely on the springy resilience of the metal to maintain high unit loading to the mating surfaces. However, at SOFC operating temperatures of 700° C. and higher, the metal C-ring would creep and lose most of the unit loading at contact surfaces. In addition, clamping bolts used to hold the object together would lose tension, thereby further reducing loading at the contact surfaces. Furthermore, the contact surfaces typically required a polished finish that often corroded and/or pitted in service, thereby creating leak paths. As the contact between the metal C-ring and contact surfaces was essentially a line contact, the seal provided by a metal C-ring was deemed susceptible to leak paths while being undesirably expensive because of the surface finishes required at the contact surfaces, and the metal C-rings themselves were relatively expensive.

Fibrous gasket seals that consisted of high temperature fibers (e.g. ceramic) with powder filler were also tested. However, the very nature of these materials is such that they do not sinter at the SOFC operating temps, but would burn out any organic fillers so that the resulting gasket was little more than a tight labyrinth and thereby not suitable for low leak performance. In addition, it was observed that the required clamp load on the fibrous gasket was difficult to maintain due to bolt length creep of the bolts holding the objects together, and the fibrous gaskets themselves had a tendency to creep and/or squeeze laterally in the joint resulting in loss of compression. A gland type of retaining geometry was effective in reducing squeeze, but gasket tolerances resulted in either inadequate fill or over filling of the gland resulting in poor sealing. Mineral gasket seals that are fabricated from materials such as mica or other minerals were also tested. These were a greater density than the fibrous gaskets, but also had problems in maintaining an adequate clamp load over time similar to the fibrous gasket seals.

A sealing technology that proved effective was compression fittings that relied on tapered ferrules for joining tubes, for example SWAGELOK® connectors. However, this technology is generally only suitable for connecting tubes to housings or tubes to tubes, occupied an undesirable large area, and they are relatively expensive.

### SUMMARY OF THE INVENTION

Described herein is a way to inexpensively form a reliable fluidic seal by deforming a simple straight tube to form a metal to metal seal. The seal described herein avoids the undesirably high require axial clamping loads of the prior art by instead relying on radial compression to effect and maintain a wide area sealing surface contact load.

In accordance with one embodiment, a seal assembly configured to provide a fluidic seal between openings into objects is provided. The assembly includes a first object, a second object, and a straight tube. The first object is configured to define a first opening that includes a first tapered section tapered from a first start diameter to a first finish diameter. The second object is configured to define a second opening that includes a second tapered section tapered from a second start diameter to a second finish diameter. The straight tube is characterized by an outer diameter less than the first start diameter and the second start diameter, and greater than the first finish diameter and the second finish diameter, wherein a fluidic seal is formed when the first object and the second object are forced together with the straight tube therebetween such that the first tapered section and the second tapered section deform the straight tube to form a seal therebetween by radial compression of the straight tube.

In accordance with one embodiment, a seal assembly configured to provide a fluidic seal with an opening into an object is provided. The assembly includes a first object and a second object. The first object is configured to define a first opening that includes a first tapered section tapered from a first start diameter to a first finish diameter. The second object is equipped with a straight tube portion characterized by an outer diameter less than the first start diameter and greater than the first finish diameter. A fluidic seal is formed when the first object and the second object are forced together such that the first tapered section deforms the straight tube portion to form a seal therebetween by radial compression of the straight tube portion.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is sectional view of a seal assembly prior to assembly in accordance with one embodiment;

FIG. 2 is sectional view of the seal assembly of FIG. 1 after assembly in accordance with one embodiment;

FIG. 3 is sectional view of an alternative seal assembly after assembly that includes a gasket in accordance with one embodiment;

FIG. 4 is a perspective view of manifolds prior to assembly that employ the seal assembly of FIG. 1 in accordance with one embodiment; and

FIG. 5 is sectional view of an alternative seal assembly after assembly in accordance with one embodiment.

### DETAILED DESCRIPTION

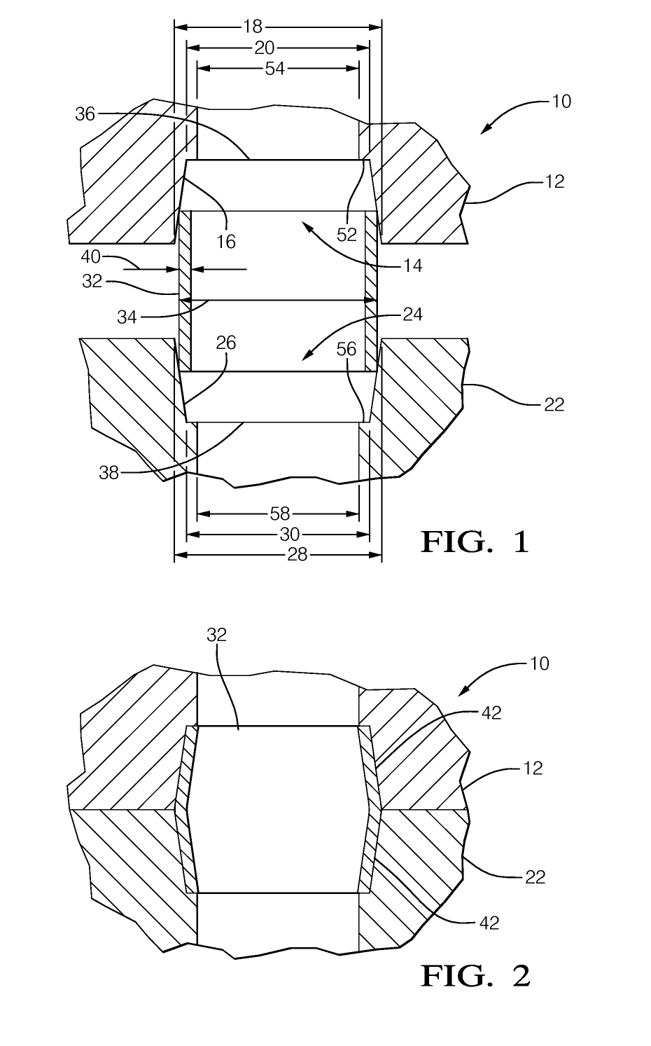

FIG. 1 illustrates a non-limiting example of a seal assembly, hereafter referred to as the assembly 10. In general, the assembly 10 is configured to provide a fluidic seal between openings into objects. In this non-limiting example, the assembly 10 includes a first object 12 configured to define a first opening 14 that includes a first tapered section 16 tapered from a first start diameter 18 to a first finish diameter 20. The first object 12 may be, or may be part of anything that produces or draws gasses or fluids through the first opening 14. For example, the first object 12 may be a solid oxide fuel cell (SOFC) or an internal combustion engine. These examples are particularly relevant as they expose the assembly 10 to widely varying temperatures, −40° C. to 800° C. for example. If the application of the assembly is a SOFC, suitable but non-limiting example dimension for the various features are a first start diameter 18 of 25.5 millimeters (mm), a first finish diameter 20 of 24.5 mm, and a length or depth of the first tapered section 16 of 10.0 mm.

The assembly 10 also includes a second object 22 configured to define a second opening 24 that includes a second tapered section 26 tapered from a second start diameter 28 to a second finish diameter 30. Like the first object 12, the second object 22 may be, or may be part of, anything that produces or draws gasses or fluids through the second opening 24. For example, the second object 22 may be an exhaust manifold connected to a solid oxide fuel cell (SOFC) or an internal combustion engine. It is expected that in many instances the first start diameter 18 and the second start diameter 28 will be equal, and the first finish diameter 20 and the second finish diameter 30 will be equal. However, if the first object 12 and the second object 22 are made of different materials, first tapered section 16 and the second tapered section 26 may have distinct geometries.

The assembly 10 also includes a straight tube 32 characterized by an outer diameter 32 less than the first start diameter 18 and the second start diameter 28, and greater than the first finish diameter 20 and the second finish diameter 30. As used herein, the term ‘straight tube’ means that the portion of the straight tube 32 that contacts the first tapered section 16 and the second tapered section 26 after the assembly 10 is assembled (FIG. 2) has an outer diameter 34 that is relatively constant prior to being deformed by the first tapered section 16 and the second tapered section 26. That is, any variation in the outer diameter of the straight tube 32 as received and prior to assembly with the first object 12 and the second object 22 is mainly due to manufacturing variability, and not, for example tapered to better match the angle of the first tapered section 16 and the second tapered section 26. As such, known examples of tapered ferrules such as those used by SWAGELOK® are specifically excluded from definition of ‘straight tube’.

However, it is contemplated that a first leading edge 36 and/or a second leading edge 38 may be radiused or otherwise finished to prevent burrs and the like from interfering with or making difficult the pressing together of the first object 12 and the second object 22. As such, any machining of the first leading edge 36 and the second leading edge 38 is limited to a distance from the leading edge of two times a wall thickness 40 of the straight tube 32. If the straight tube 32 is cut from tube stock, it is contemplated that the burrs that can arise from some cutting techniques may be removed by tumble finishing or tumbling, as will be recognized by those in the art. For the example dimensions given above for the first opening 14, a suitable dimension for the outer diameter 34 is 25.0 mm, and a suitable dimension for the wall thickness 40 is 1.0 mm.

The first tapered section 16 proximate to the first finish diameter 20 may include a first step 52 that steps the diameter of the first opening 14 from the first finish diameter 20 to a first passageway diameter 54. Similarly, second tapered section 26 proximate to the second finish diameter 30 may include a second step 56 that steps the diameter of the second opening 24 from the second finish diameter 30 to a second passageway diameter 58. The first step 52 and/or the second step 56 may serve as a depth stop for the straight tube 32 when being inserted or pressed into the first object 12 and/or the second object 22 to control the insertion depth into the respective objects. Preferably, the size of the steps, that is the difference between the respective finish diameters and passageway diameters, is selected so the transition from the inside of the straight tube 32 to the respective passageways is relatively smooth after assembly. For example, the steps may be roughly equal to the wall thickness 40 of the tube to provide smooth fluid flow.

FIG. 2 illustrates a non-limiting example of the assembly 10 where a seal 42 is formed when the first object 12 and the second object 22 are forced together with the straight tube 32 located as shown in FIG. 1 prior to assembling or forcing together. The seal 42 is formed when the first tapered section 16 and the second tapered section 26 deform the straight tube 32 to form the seal 42 therebetween by radial compression of the straight tube 32. Accordingly, the straight tube is preferable formed of a relatively malleable material such as Alloy 316 stainless steel, or an INCONEL® alloy. Furthermore, the first object 12 and the second object 22 are preferably formed of a material that is hard enough so that the straight tube 32 does not damage the first tapered section 16 and the second tapered section 26 when the first object 12 and the second object 22 are forced together. A suitable material for the first object 12 and the second object 22 is a 300 series stainless steel (such as 302, 304, 316), a 400 series stainless steel (such as 430 or 441), or a high temperature alloy (such as an Inconel alloy). Alternatively, the first tapered section 16 and the second tapered section 26 may be heat treated to be harder than the bulk of the first object 12 and the second object 22 as will be recognized by those in the art.

While not specifically illustrated, the first object 12 and the second object 22 may be drawing together with the bolt that remain to keep the first object 12 and the second object 22 together. Alternatively, the first object 12 and the second object 22 may be forced together using a vice or press, and then rivets or bolts may be used to keep the first object 12 and the second object 22 together.

In this non-limiting example, the first object 12 and the second object 22 are illustrated as being in contact after the assembly 10 is assembled. However, it is contemplated that the first object 12 and the second object 22 may be spaced apart if the straight tube 32 is sufficiently deformed so that the seal 42 is reliable and relatively leak free before the first object 12 and the second object 22 are forced together. It is also illustrated that the length of the straight tube 32 is such that the first leading edge 36 and/or the second leading edge 38 extend, respectively, to the end of the first tapered section 16 and the second tapered section 26. However, this is not a requirement as it is contemplated that the seal 42 can be made sufficiently reliable and leak free if the leading edges are short of the ends of the tapered sections.

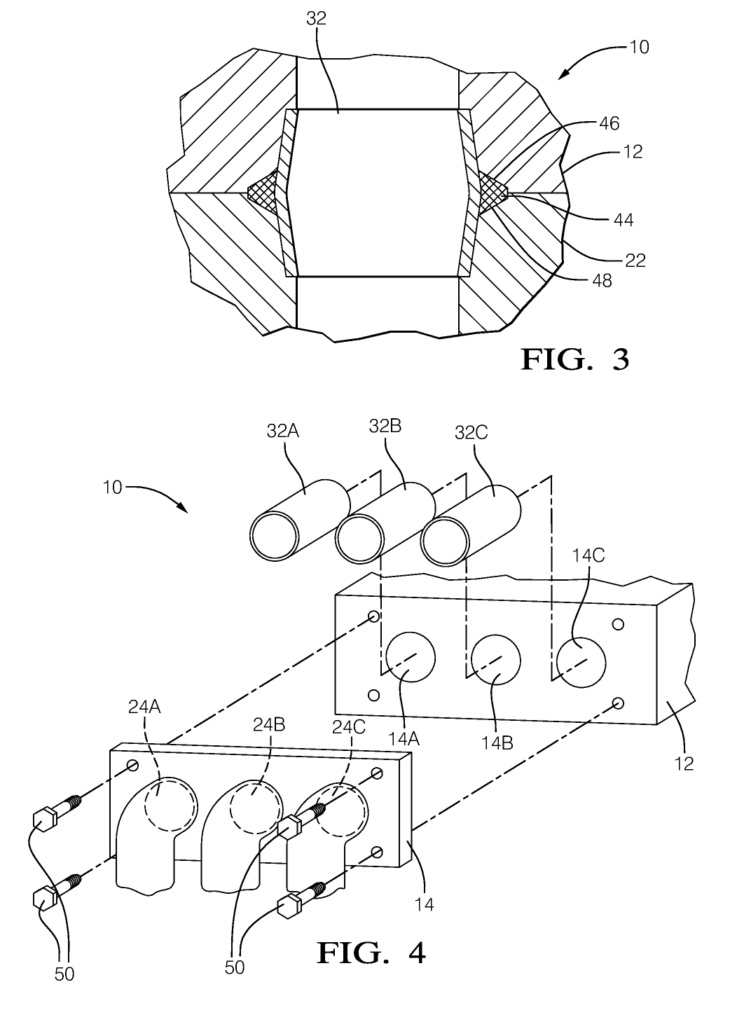

FIG. 3 illustrates a non-limiting alternative example of the assembly 10 that optionally includes a gasket 44 around the straight tube 32. If necessary because, for example, the first object 12 and the second object 22 are in contact when assembled, the first object 12 may include or define a first bevel portion 46, and/or the second object 22 may include or define a second bevel portion 48 configured to cooperate with the gasket 44 to seal against the straight tube 32. It is recognized that the straight tube 32 is no longer straight after the first object 12 and the second object 22 are forced together. Nevertheless, the term ‘straight tube’ is used to distinguish that part from parts that are machined or preformed to provide a mating surface geometrically aligned with the first tapered section 16 and/or the second tapered section 26.

FIG. 4 illustrates a non-limiting example of the assembly 10 where the first object 12 is a manifold that defines a first plurality of openings 14A, 14B, and 14C. The second object 22 may also be a manifold that defines a second plurality of openings 24A, 24B, and 24C arranged to align with the first plurality of openings 14A, 14B, and 14C. As in the examples given above, each of the openings would include or define tapered sections suitable to deform each of a plurality of straight tubes 32A, 32B, and 32C. By way of further example and not limitation, the assembly 10 may use bolts 50 to draw or force together and fasten the first object 12 to the second object 22.

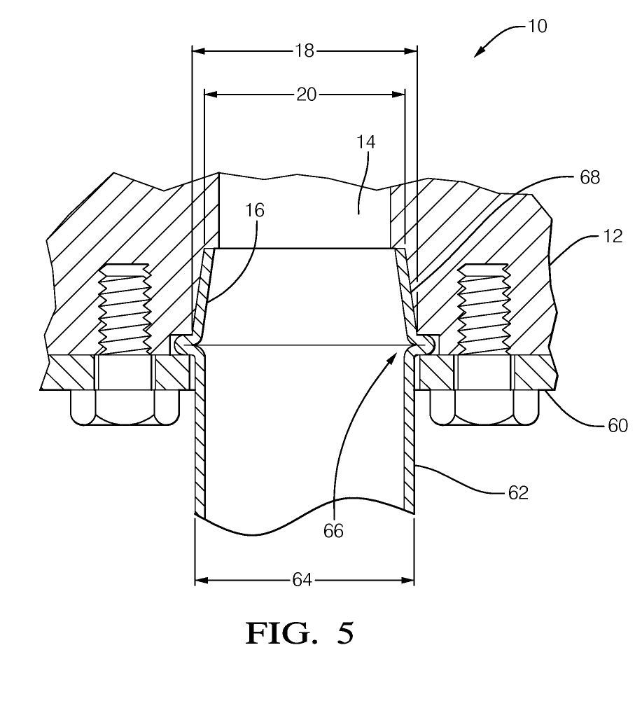

FIG. 5 illustrates a non-limiting alternative example of the assembly 10 configured to provide a fluidic seal with an opening into an object. Like the previous examples, the first object 12 configured to define a first opening 14 that includes a first tapered section 16 tapered from a first start diameter 18 to a first finish diameter 20. A key difference with this example is that, in effect, the second object 22 and the straight tube 32 are preassembled, and hereafter referred to as the second object 60. In other words, the second object 60 is equipped with a straight tube portion 62 characterized by an outer diameter 64 less than the first start diameter 18 and greater than the first finish diameter 20. In this example, the straight tube portion 62 is equipped with a bead section 66 formed into straight tube portion 62 so that the second object 60 can be used to force or drive the straight tube portion 62 into the first opening. Alternatively the second object 60 and the straight tube portion 62 may be fixedly attached by, for example, welding to form a more unitary part for mating with the first object. Accordingly, a fluidic seal is formed when the first object 12 and the second object 60 are forced together such that the first tapered 16 section deforms the straight tube portion 62 to form a seal 68 therebetween by radial compression of the straight tube portion 62.

Accordingly, a seal assembly (the assembly 10) is provided. The assembly 10 relies on a relatively short length of straight tube fabricated from a high temperature alloy which is radially compressed by tapered sections of bores or openings machined into the objects to be joined. As the straight tube is compressed and deformed by the tapered sections, hoop compression stresses are generated in the straight tube which result in relatively large contact forces between the tapered sections and the straight tube. Advantageously, these contact forces are spread over a relatively large area. Testing has shown that after sufficient time at temperatures representative of SOFC operating temperatures that are known for creep to occur, the residual stresses in the straight tube will still maintain an effective sealing surface contact load, even with a the straight tube formed of a relatively low cost material such as SS316. The low angle on the tapered sections provides a substantial mechanical advantage such that reasonable axial loads (e.g. provided by axial bolts) will reliably join the mating parts. However, once joined, minimal axial loading is required to maintain the seal or joint. It has been observed that only axial loading sufficient to provide dimensional stability is necessary.

Since the straight tube 32 deforms to match the tapered sections 16, 26, there is a relatively large area of sealing contact (the seal 42) which minimizes or eliminates the potential for oxidation and/or pitting in the seal 42 that could lead to leaks. In addition, the sealing function of the seal 42 can be further enhanced by plating a layer of conformable metal such as nickel to the surface of the straight tube 32. This conformable metal would fill micro defects between the sealing surfaces of the straight tube 32 and the tapered sections 16, 26, and provide an oxidation barrier. Furthermore, at SOFC operating temps, this nickel would form a diffusion bond between the sealing surfaces.

It is also recognized that since the bores are tapered, the straight tube 32 could be at a slight angle relative to the bore centerline of an opening and still be formed to the shape of the bore by taking on a slight elliptical shape. In this way the straight tube can accommodate some misalignment between the openings of two mating housings. As such, multiple passages or openings of manifolds can be reliably sealed between two manifolds since the mating bore alignments do not have to be perfect. Further, this means that thermal expansion differences can be accommodated between the mating manifolds if different materials are used for the first object 12 and the second object 22.

This sealing technology will be inexpensive to manufacture since tapered bores are relatively easy to machine, and the cost of the straight tube material is relatively low and readily available. The straight tube could also be formed from sheet stock by utilizing an eyelet stamping process which would be even lower cost and better uniformity than is expected if using tube stock. Furthermore, the assembly 10 can be serviceable, as the tapered section could be restored with a simple tool such as a tapered reamer and/or dressing stone. Test results have shown the assembly 10 described herein to have relatively low leak rates (i.e. lower than other technologies evaluated).

While this invention has been described in terms of the preferred embodiments thereof, it is not intended to be so limited, but rather only to the extent set forth in the claims that follow.

We claim:

1. A seal assembly configured to provide a fluidic seal between openings into objects, said assembly comprising:
a first object configured to define a first opening that includes a first tapered section tapered from a first start diameter to a first finish diameter;
a second object configured to define a second opening that includes a second tapered section tapered from a second start diameter to a second finish diameter; and
a straight tube characterized by an outer diameter less than the first start diameter and the second start diameter, and greater than the first finish diameter and the second finish diameter, wherein a fluidic seal is formed when the first object and the second object are forced together with the straight tube therebetween such that the first tapered section and the second tapered section deform the straight tube to form a seal therebetween by radial compression of the straight tube.

2. The assembly in accordance with claim 1, wherein the first start diameter equals the second start diameter.

3. The assembly in accordance with claim 1, wherein the first finish diameter equals the second finish diameter.

4. The assembly in accordance with claim 1, wherein the assembly includes a gasket around the straight tube.

5. The assembly in accordance with claim 4, wherein the first object defines a first bevel portion configured to cooperate with the gasket to seal against the straight tube.

6. The assembly in accordance with claim 4, wherein the first object and the second object define, respectively, a first bevel portion and a second beveled portion, wherein the first bevel portion and the second beveled portion are configured to cooperate with the gasket to seal against the straight tube.

7. The assembly in accordance with claim 1, wherein the first object is a manifold that defines a first plurality of openings.

8. The assembly in accordance with claim 1, wherein the second object is a manifold that defines a second plurality of openings arranged to align with the first plurality of openings.

9. A seal assembly configured to provide a fluidic seal with an opening into an object, said assembly comprising:
a first object configured to define a first opening that includes a first tapered section tapered from a first start diameter to a first finish diameter;
a second object equipped with a straight tube portion characterized by an outer diameter less than the first start diameter and greater than the first finish diameter, wherein a fluidic seal is formed when the first object and the second object are forced together such that the first tapered section deforms the straight tube portion to form a seal therebetween by radial compression of the straight tube portion.
